(19) United States
(12) Patent Application Publication
(10) Pub. No.: US 2022/0252477 A1
(43) Pub. Date: Aug. 11, 2022

(54) DETERMINING AN ACTUAL VALUE AND/OR AN ACTUAL VALUE RANGE OF AT LEAST ONE STATE VARIABLE OF A FLUID IN A FLUID FLOW BY MEANS OF AT LEAST ONE INDICATOR PARTICLE

(71) Applicant: Universität Stuttgart, Stuttgart (DE)

(72) Inventor: Carsten Mehring, Nagold (DE)

(21) Appl. No.: 17/733,898

(22) Filed: Apr. 29, 2022

(30) Foreign Application Priority Data
Nov. 12, 2019 (DE) 102019217470.1

(51) Int. Cl. G01L 23/00

(52) U.S. Cl. CPC G01L 23/00

(57) ABSTRACT

The invention relates to a method for determining an actual value and/or an actual value range of at least one state variable of a fluid in a fluid flow by means of at least one indicator particle (9) introduced into the fluid. In addition it is proposed that the at least one indicator particle (9) is designed and provided for an irreversible property change of an indicator property of the indicator particle (9) in the case of a certain indicator value of the at least one state variable in the fluid flow and/or as a clear function of the actual value when a certain period of time has elapsed after the indicator particle (9) has been introduced into the fluid, wherein the indicator particle (9) is detected at a detection point, the indicator property of the indicator particle (9) is evaluated and the actual value and/or the actual value range of the state variable is inferred from the indicator property upstream of the detection point. The invention also relates to a method for operating a fluid-guiding device (7), an indicator particle (9) and a device (7) for determining the actual value and/or actual value range of the at least one state variable.

### CROSS-REFERENCE TO RELATED APPLICATIONS

This application is a continuation of International Application PCT/EP2020/081631, filed Nov. 10, 2020, which claims priority to German Patent Application 10 2019 217 470.1, filed Nov. 12, 2019, the content of each of which is incorporated herein by reference in its entirety.

### DESCRIPTION

The invention relates to a method for determining an actual value and/or an actual value range of at least one state variable of a fluid in a fluid flow using at least one indicator particle introduced into the fluid. The invention also relates to a method for operating a fluid-guiding device, an indicator particle and a device for determining the actual value and/or the actual value range of the at least one state variable.

The publication GB 2510862 A, for example, is known from the prior art. This describes a speed measurement based on imaging processes. The so-called Defocused Digital Particle Image Velocimetry method (DDPIV method) is used here. This includes the introduction of particles into a fluid, wherein the particles are detected at a measuring point and used to determine a velocity field of the fluid. In order to additionally determine a temperature of the fluid at the measuring point, thermal liquid crystals can be added to the fluid.

It is the object of the invention to propose a method for determining the actual value and/or the actual value range of the at least one state variable of the fluid in the fluid flow, which has advantages over known methods, in particular also for such points or regions of a fluid-guiding device enables findings about the state variable, which are not accessible for a direct measurement at these points or in these regions.

According to the invention, this is achieved with a method for determining the target value of the at least one state variable of the fluid with the features of claim 1. It is provided that the at least one indicator particle is provided and designed for an irreversible property change of an indicator property of the indicator particle in the presence of a specific indicator value of the at least one state variable in the fluid flow and/or depending on or as a clear function of the actual value at the end of a specific period of time after the introduction of the indicator particle in the fluid, wherein the indicator particle is detected at a detection point, the indicator property of the indicator particle is evaluated and the actual value and/or the actual value range of the state variable is inferred from the indicator property upstream of the detection point.

The method is used, for example, to operate a device for determining the actual value or the actual value range and/or to operate a fluid-guiding device, in particular for controlling and/or regulating the device. As part of the method, the actual value and/or the actual value range of the state variable is to be determined, namely at a point which is upstream of the actual detection point. That point or that region at which or in which the actual value and/or the actual value range is or should be determined can also be referred to as an examination point or as an examination region.

The actual value is the actual value of the state variable at the examination point. The actual value range, on the other hand, describes a range in which the actual value lies. The actual value range can be a closed or semi-closed mathematical interval. The actual value range is therefore either closed on both sides or only on one side or limited by a respective limit value. In the case of the closed interval, the actual value range is limited on the one hand, for example downwards, by a first limit value and on the other hand, for example upwards, by a second limit value, wherein the first limit value and the second limit value are different from one another. In the case of the half-open interval, the actual value range is limited only by the first limit value or the second limit value and is open in the direction of the other limit value in each case. Using the actual value range allows the actual value to be limited to a specific range. It should already be pointed out at this point that if the actual value is mentioned in the context of this description, the actual value range is always meant additionally or alternatively, even if it is not explicitly mentioned.

In principle, the actual value and/or the actual value range is determined with the aid of the at least one indicator particle. This is introduced into the fluid, namely at an introduction point which is in the fluid flow upstream of the examination point. The indicator particle passes through the fluid flow along a trajectory, starting from the introduction point via the examination point to the detection point, at which the indicator particle is evaluated. Since the trajectory of the indicator particle in the fluid flow and its time-dependent position along the trajectory after its introduction into the fluid flow are initially not known, it can be provided to determine the trajectory using suitable methods in order to determine the location of the examination site. The actual value and/or the actual value range can then be assigned to the examination site.

If the indicator particle is mentioned in the context of this description, the corresponding explanations can always be transferred to the at least one indicator particle and vice versa. Incidentally, this also applies to the state variable, wherein corresponding statements apply to the at least one state variable and vice versa. In this respect, the respective statements are congruent. Likewise, several indicator particles can be used within the scope of the method. In this case, the explanations for the indicator particle and the at least one indicator particle are preferably applicable to a plurality of the indicator particles or each of the plurality of indicator particles. In this respect, the corresponding statements can always be used in a supplementary and analogous manner.

The method can be used to determine the actual value and/or the actual value range of exactly one state variable or to determine actual values and/or actual value ranges of a plurality of state variables. In the latter case, the explanations for the state variable or the at least one state variable can preferably be transferred to each of the several state variables. In a first embodiment, the indicator particle is designed in such a way that it changes its indicator property with certain properties of the fluid, i.e. as soon as the state variable of the fluid has the specific indicator value. When it is introduced into the fluid at the point of introduction, the indicator particle has a specific property that changes as soon as the indicator particle reaches a point in the fluid at which the state variable has the specific indicator value. For example, the changing property is one of the following properties: Size, shape, weight, color, reflectance, refractive index, material composition, material structure, or the like. If the indicator value is present in the fluid along the trajectory of the indicator particle, the size, shape, weight, color, degree of reflection, refractive index and/or the material structure of the indicator particle change permanently and irreversibly. Of course, several of the properties mentioned can change as soon as the state variable at the point at which the indicator particle is currently present has the indicator value. The material composition is to be understood as meaning a composition of the material of which the indicator particle consists at least in some regions, in particular a chemical composition. The material structure describes, for example, a crystalline structure or crystal structure of the indicator particle or the material.

In a second embodiment, the indicator property changes depending on, or in other words as a clear function of, the actual value and/or the actual value range, namely when the specific period of time has elapsed after the indicator particle was introduced into the fluid. This means that the indicator property initially remains constant after the indicator particle has been introduced into the fluid, regardless of the state variable of the fluid or its actual value and/or actual value range, namely over the specific period of time. Only when the period of time has elapsed, i.e. at the end, does the indicator particle react to the state variable, namely exactly once. The indicator property is changed depending on or as a clear function of the state variable or its actual value and/or actual value range and subsequently remains—preferably—constant again.

The period of time is realized, for example, by means of a protective cover for the indicator particle. The indicator particle is preferably designed in such a way that the change in the indicator property takes place after the time period has elapsed depending on or as a clear function of the actual value of the state variable that is then present. Of course, in a combination of the first embodiment and the second embodiment, it can also be provided that the indicator particle is designed in such a way that the change in the indicator property according to the first embodiment occurs when the specific indicator value of the at least one state variable is present in the fluid flow, wherein the change only is released after the specified period of time has elapsed.

Particularly preferably, it can be provided for a third embodiment of the indicator particle, which is moreover preferably based on the first embodiment and further develops it, that an irreversible property change of the respective surface element or volume element with a state variable value-sensitive indicator property takes place progressively over time over the particle surface or the particle volume. Provision can be made here for the indicator property to change when a specific indicator value is present, or for the indicator property to change depending on or as a clear function depending on the actual value of the state variable in the fluid. For example, it is provided that several sensor elements or sensor regions are formed on the base body, wherein a first part of the sensor elements or sensor regions have a first indicator value or a first indicator property and a second part of the sensor elements or sensor regions have a second indicator value or a second indicator value different from the first indicator value has a second indicator property that is different from the first indicator property. Insofar as the indicator property is discussed in the context of this description, it can be understood, for example, as an indicator value. The first indicator property then corresponds to the first indicator value and the second indicator property to the second indicator value. For example, the first part of the sensor elements or sensor regions consists of a sensor material and the second part of the sensor elements or sensor regions consists of a sensor material that is different from the sensor material. The sensor elements or sensor regions can be designed in such a way that they are subjected to a chemical surface reaction as soon as they come into contact with the fluid; in particular, a surface reaction that is dependent on the actual value takes place.

Of course, any number of parts or regions that differ in terms of their indicator properties can be implemented. For example, the parts or regions are designed in such a way that they have the same indicator property, but the property change occurs after different exposure times. This means that along the trajectory in the fluid flow, the property changes of the parts or regions take place at different points in time, depending on the indicator value or as a clear function of the actual value of the state variable in the fluid at the respective point in time. When detecting the indicator particle, it can be determined at what point in time or where on the trajectory of the indicator particle the determined actual value of the state variable was present, or on what part of the trajectory or in what period of time the indicator particle was exposed to the actual value range limited by the indicator value.

The frequency with which changes in the indicator property of the different sensor elements or sensor regions are perceived over time can be referred to as the progression rate. In any case, it can be provided—but purely optionally—that the sensor elements or sensor regions are covered by the protective cover with different cover thicknesses, so that the rate of progression is ultimately determined by the protective cover or its cover thicknesses.

The change in property is irreversible, which means that a one-time presence of the specific indicator value of the state variable and/or the elapse of the period of time is sufficient to cause the property change permanently, namely starting from an original indicator property, to which the indicator property of the indicator particle at its introduction into the fluid corresponds, to a changed indicator property, which the indicator particle assumes after the presence of the indicator value and/or after the period of time has elapsed. This means that even if the state variable subsequently deviates from the indicator value, the property of the indicator particle remains at the changed property and no longer assumes the original property. Thus, in the case of an indicator particle of the first embodiment, a single presence of the specific indicator value in the fluid flow along the trajectory between the introduction point and the detection point can be determined by detecting the indicator particle and evaluating the indicator property. For example, it is thus possible in a simple manner to check for the presence of disadvantageous flow effects in the fluid flow clearly downstream of that point at which they actually occur. For example, if the indicator particle is suitably designed, the method can be used to determine whether or not cavitation is occurring in the fluid-guiding device, which is designed, for example, as a pump, in particular as a suction jet pump, or in the fluid flow present in the fluid-guiding device, namely in particular by means of the first embodiment of the indicator particle. Cavitation is characterized by the collapse of cavitation bubbles and the resulting high pressure. Correspondingly, the pressure is used as a state variable for checking for cavitation and the indicator value is selected in such a way that the indicator particle reacts to the cavitation, i.e. in particular a high pressure, with the reversible change in properties. If the indicator particle shows its original indicator properties at the detection point, i.e. downstream of the examination point, it can be assumed that there is no cavitation or that the pressure along the trajectory has not exceeded the indicator value. If, on the other hand, the changed indicator property is present, then the presence of cavitation or a pressure that is higher than the indicator value is recognized.

The presence of the specific indicator value means in particular that the actual value of the state variable corresponds to the indicator value or at least lies in a range—also referred to as the actual value range—which is limited by the indicator value, namely, for example, upwards or downwards. In this respect, the indicator value delimits a value interval on one side, which on the other hand is open. As soon as the actual value is present in the value interval, the condition for the irreversible property change of the indicator property to expire is fulfilled. The indicator property changes irreversibly, preferably when the actual value of the at least one state variable corresponds to or is greater than the indicator value or alternatively corresponds to the indicator value or is smaller, i.e. is in the actual value range defined by the indicator value. However, it can also be provided that the indicator value is to be understood as meaning the value interval itself, so that the indicator value is present as an indicator value range. This indicator value range has both upper and lower limits. The determined indicator value is then available as soon as the actual value of the state variable is in the indicator value range, so that the irreversible property change follows from this, which is retained even after the actual value has possibly left the indicator value range. If the actual value is mentioned in the context of this description, the actual value range is also always meant implicitly in addition or as an alternative, so that the corresponding statements can also be applied to this, even if it is not explicitly mentioned.

To determine the actual value and/or the actual value range, the indicator particle is detected at the detection point. In principle, this can be done in any manner, wherein preference is to non-intrusive methods, for example optical or imaging methods, of course. Upon or after the detection of the indicator particle, its indicator property is evaluated. This evaluation can be done both directly and indirectly. In the first case, the indicator property is preferably measured in the course of detecting the indicator particle. However, provision can also be made for the indicator property to be determined only indirectly, namely by measuring a property which differs from the indicator property but is dependent on it, from which the indicator property is then subsequently inferred.

After the indicator property has been evaluated, it is used to determine the actual value or the actual value range of the state variable which is/are present at the examination point and consequently upstream of the detection point. Because initially the actual value or actual value range is not known at the examination site and the indicator particle can, for example, only reflect two different states that describe the state variable along the entire flow path or the entire trajectory, it may be necessary to place a plurality of different indicator particles having different indicator values in the fluid, record them at the detection point and evaluate the respective indicator property in order to actually arrive at the actual value or actual value range of the state variable at the examination point. The described detection of actual values or actual value ranges of the state variable of a fluid flow on the path line or trajectory of an indicator particle corresponds to a Lagrangian description of the fluid flow.

In order to determine the actual value or the actual value range of the state variable of the fluid at a specific point in the fluid flow or in a specific region of the fluid flow (so-called Eulerian description of the fluid flow) using the described basic procedure using one or more indicator particles (Lagrangian description), it may be necessary to create indicator particles of the above-mentioned embodiments, also of different embodiments, as well as a representative computer model of the fluid flow and the trajectories of the indicator particles placed therein (so-called digital twin). This will be discussed further below.

In principle, the indicator particle can be detected in any manner, as long as the indicator property is also detected directly or at least indirectly. For example, the indicator particle can be detected as part of the PIV method (PIV: Particle Image Velocimetry) or the PTV method (PTV: Particle Tracking Velocimetry). In these cases, in addition to the indicator property and thus the actual value or actual value range of the state variable at the detection point, the speed or the speed field of the fluid or the fluid flow can be determined at the detection point. In addition, the position and the speed vector of the indicator particle can be determined. The PIV method is based on a Eulerian approach to fluid flow, whereas the PTV method uses the Lagrangian approach. However, it is of course also possible to detect the indicator particles in which the speed field and/or the position and speed of the indicator particle are not (also) detected.

The procedure described has the advantage that it is also possible to determine the actual value or actual value range at inaccessible points of the fluid-guiding device, namely by starting from the state of the indicator particle at the detection point, namely the indicator property, the actual value or actual value range of the state variable of the fluid at the upstream inspection site is inferred. In view of this clear advantage, it can certainly be accepted that the actual value or actual value range determined using the method described may have a greater error at the examination site than with a direct measurement directly at the examination site. It can also be accepted that due to the only indirect determination of the actual value or actual value range, possibly several different indicator particles, i.e. indicator particles with different indicator values and/or time periods up to a change in the indicator property as a clear function of the actual value of the state variable and/or indicator particles of different embodiments, must be used until the actual value, i.e. the value of the state variable along the trajectory, or the actual value range can be determined with an acceptable error. It can also be accepted that a representative computer model of the fluid flow and the trajectories of the indicator particles placed therein (so-called digital twin) is required to infer the actual value or the actual value range of the state variable at a specific, spatially defined examination point in the fluid flow (Euler's description), in order to infer from the recorded indicator properties of the indicator particles (Lagrangian description) the actual value or the actual value range of the previously spatially determined examination site.

A development of the invention provides that the at least one indicator particle is part of a large number of indicator particles that are introduced into the fluid, wherein the indicator value of the state variable corresponds to a first indicator value for a first part of the indicator particles and to a second indicator value for a second part of the indicator particles and/or the period of time, in particular until the indicator property changes as a clear function of the actual value of the state variable, to a first period of time for the first part of the indicator particles and to the second period of time for the second part of the indicator particles. In principle, any number of indicator particles can be supplied to the fluid, namely, for example, at least partially at the point of introduction. The at least one indicator particle already mentioned above forms one of the several indicator particles, i.e. is not present in addition to these. The indicator particles are now divided into several parts, for example into two parts. Provision can be made here for each of the parts to have the same number of indicator particles. Of course, however, one of the parts can also contain more or fewer indicator particles than one of the other parts.

The indicator particles of the different parts differ with regard to the indicator value and/or the period of time, in particular up to a change in the indicator property as a clear function of the actual value of the state variable. For the first part of the indicator particles, the indicator value corresponds to the first indicator value or the first period of time and for the second part to the second indicator value or the second period of time. In other words, the first part has one or more indicator particles with the first indicator value or the first time period and the second part has one or more indicator particles with the second indicator value or the second time period. Of course, however, any number of parts can be present, i.e., for example, a third part, a fourth part and/or a fifth part can also be present. The use of the indicator particles with the different indicator values or the different periods of time enables a particularly precise determination of the actual value or actual value range of the state variable.

A development of the invention provides that the first part of the indicator particles and the second part of the indicator particles are introduced into the fluid at the same time or with a time-delayed manner and/or at the same introduction point or at introduction points spaced apart from one another, wherein the first part is introduced into the fluid with an unchangeable first identification independent from the respective indicator property and the second part is provided with an unchangeable second identification independent of the respective indicator property. The identification of the indicator particles, i.e. both the first identification and the second identification, serves for a simple identification of the respective indicator particle, despite the possible change in properties. For this purpose, the identifications are unchangeable and, above all, independent of the respective indicator property. Changing the respective indicator property does not result in a change in the identification, rather it remains the same permanently.

The first part of the indicator particles has the first identification and the second part has the second identification, wherein the first identification and the second identification differ from one another in such a way that when the indicator particles are detected at the detection point, the indicator particles can be assigned to the first part and the second part. This means that the identification is determined for an indicator particle detected at the detection point, preferably for each of the detected indicator particles, and the indicator particle is assigned to the part of the indicator particles that corresponds to the identification.

For example, the indicator particles are provided with a corresponding identification depending on the original indicator property and/or the respective point of introduction and/or the respective point in time of introduction. In this respect, the identification is selected as a function of at least one or more of the parameters or indicator properties mentioned, so that when the indicator particles are detected at the detection point, the indicator particles can be unambiguously assigned. Indicator particles for which there are different parameters or indicator properties have different identifications, whereas indicator particles with the same parameters or indicator properties have the same identifications.

In principle, the indicator particles of the several parts can be introduced simultaneously or at different times. In the former case, all the indicator particles of the several parts are introduced into the fluid at the same time, in the latter case this takes place with a time delay, i.e. with a time interval. In addition or as an alternative, it can be provided that the indicator particles of the several parts are introduced into the fluid at the same point of introduction or at points of introduction that are spaced apart from one another. This allows a high temporal and/or spatial resolution of the actual value or actual value range of the state variable in the fluid flow to be achieved, so that a higher level of detail with regard to the actual value and/or the actual value range or the fluid flow is achieved. The introduction of the indicator particles is particularly preferably carried out simultaneously at introduction points which are spaced apart from one another or in a time-delayed manner at the same introduction point. However, the time-delayed introduction at spaced-apart introduction points and the simultaneous introduction at the same introduction point can also be useful.

A further development of the invention provides that the at least one indicator particle is detected and the indicator property is evaluated without contact in the fluid or after the at least one indicator particle has been removed from the fluid. This has already been pointed out. The non-contact detection and evaluation is carried out, for example, optically, in particular by means of an optical sensor or an image-capturing camera.

The optical sensor is based, for example, on light scattering (reflection, refraction and/or diffraction) and/or light absorption of the indicator particle. Alternatively, the indicator particle can also first be removed from the fluid and its indicator property can only be evaluated after removal. This is done, for example, by microscopic image acquisition (SEM/SEM or TEM) or non-contact spectroscopic evaluation using an aerosol mass spectrometer. Additionally or alternatively, the evaluation is carried out tomographically.

A combination of the two procedures mentioned is also fundamentally possible. In this case, for example, the indicator particle is initially detected without contact, in particular optically and preferably with the detection of the velocity field of the fluid or the speed of the indicator particle at the detection point. After contactless detection, the indicator particle is removed from the fluid, the indicator property is evaluated and the actual value or actual value range of the state variable along the trajectory or at the examination point is inferred from this. This achieves a particularly high degree of flexibility in the method described.

A development of the invention provides that if the property change does not occur, the indicator value is changed until the property change occurs, or if the property change occurs, the indicator value is changed until the property change does not occur, wherein the indicator value I₁ at which the property change for the first time has failed to materialize, and the actual value or actual value range of the state variable is inferred from the indicator value I₂, at which the property change occurred for the first time. In other words, it is provided that if the property change does not occur, the indicator value is changed until the property change occurs, or if the property change occurs, the indicator value is changed until the property change does not occur, wherein a first indicator value of the indicator value at which the property change did not occur, and the actual value or actual value range of the state variable is inferred from a second indicator value of the indicator value at which the property change occurred.

In other words, several indicator particles with different indicator values are used, for example indicator particles which partly have a first indicator value and partly have a second indicator value. It is provided here that the first part of the indicator particles is first introduced into the fluid and the indicator property is evaluated at the detection point. If the indicator property corresponds to the original indicator property, i.e. if there has been no change in property, then the second part of the indicator particles with the second indicator value that differs from the first indicator value is introduced into the fluid, for example at the same introduction point. If the property change does not occur again, indicator particles with an additional indicator value that differs from the first indicator value and the second indicator value are introduced into the fluid. This is carried out and the indicator value is changed accordingly until the property change occurs for the first time (specifically at I₂) and is determined during the evaluation.

If the property change is already established for the first part of the indicator particles, then the indicator value is also changed and the second part of the indicator particles is introduced. Here, the indicator value is changed until the property change does not occur for the first time (at I₁). So if the property change also occurs for the second part of the indicator particles, the third part of the indicator particles is introduced into the fluid, which from the first indicator value and the second indicator value have another indicator value. In particular, this procedure is only interrupted as soon as there is no change in the properties of the indicator particles.

The first indicator value I₁ and the second indicator value I₂ are now determined from the different indicator values of the indicator particles introduced into the fluid. The first indicator value is the indicator value of an indicator particle in which the property change did not occur for the first time and the second indicator value is the indicator value of such an indicator particle in which the property change occurred for the first time. The first indicator value I₁ and the second indicator value I₂ are preferably selected in such a way that their values are as far apart as possible. The first indicator value and the second indicator value therefore delimit the actual value or actual value range of the state variable in the fluid flow. Consequently, the actual values of the maximum and minimum values of the state variable or the actual value range of the state variable with regard to the examined examination points can be inferred particularly precisely from the two indicator values. If the examination sites are spatially in the immediate vicinity, the determined indicator values I₁ and I₂ approach one another and correspond to the actual value at the examination site.

The indicator value of an indicator particle can be changed from the first to the second indicator value in different ways. For example, the actual value of the minimum value of the state variable is set to the mean of the first indicator value and the second indicator value if there is no property change for the first indicator value and a property change takes place for the second indicator value. However, it can also be provided that more complex methods, in particular methods not based on averaging, are used for determining the actual values of the maximum and minimum values of the state variable or of the actual value range. For example, the actual values of the maximum and minimum values of the state variable or the actual value range of the state variable are determined from the indicator property of the indicator particle or the indicator values of the multiple indicator particles using machine learning and/or a neural network. This also applies regardless of the procedure described for using the different indicator values. This enables a particularly precise and time- and cost-efficient determination of the actual values of the maximum and minimum values of the state variable or of the actual value range of the state variable with regard to the examination points used.

A development of the invention provides that using a model of the fluid flow and/or the movement of the indicator particle in the fluid flow, at least one predicted value or a predicted value range for the state variable, in particular along the trajectory of the at least one modeled indicator particle, is calculated and verified using the at least one indicator particle is verified, wherein if the prediction value or the prediction value range deviates from the actual value or actual value range determined by means of the at least one indicator particle, the model is adjusted to the actual value or actual value range. The model is in particular in the form of a digital twin (digital twin) of the fluid flow or the fluid-guiding device. In this respect, the model is provided and designed to determine the behavior of the fluid flow and thus the movement of the indicator particle, for example in the form of the trajectory, in particular at least spatially resolved. In addition, a temporal resolution of the behavior of the fluid flow can be taken into account by the model. The model is based, for example, on the finite difference, finite volume, finite element or mesh-free method.

The model is used to calculate the at least one prediction value or range of prediction values for the state variable and/or the movement of the indicator particle or the trajectory. The prediction value is to be understood as meaning a value of the state variable which the state variable has according to the model at a specific point, in particular the examination point. The prediction value range is to be understood as meaning a value range of the state variable in which the state variable is located according to the model within a specific time period or within a specific distance along the trajectory. In order to check or verify the prediction value or the prediction value range, the at least one indicator particle is introduced into the fluid. When it reaches the detection point, the indicator particle is detected and its indicator property is evaluated. The actual value or actual value range of the state variable is subsequently inferred from the indicator property. If the actual value corresponds to the predicted value or if the actual value range corresponds to the predicted value range, the model can be regarded as confirmed, at least with regard to the actual value at the examination point or with regard to the actual value range along the examined stretch of the trajectory. Of course, a plurality of prediction values or ranges of prediction values can be determined and verified in the manner described by means of one or more indicator particles.

If, on the other hand, the actual value or the actual value range deviates from the prediction value or the prediction value range or if these are not consistent, then the current model is not sufficient to describe the fluid flows completely and correctly. For this reason, the model is corrected in such a way that the at least one (recalculated) prediction value or prediction value range corresponds to the actual value or actual value range, at least within a specified tolerance. Provision can be made for the procedure described to be repeated several times, in particular for a large number of different examination points or for a large number of different paths along a trajectory, so that the model is checked and adapted to the actual fluid flow in detail. In this case, a new prediction value or a new prediction value range is calculated and verified in the manner described, so that ultimately there is a plurality of prediction values or prediction value ranges.

The prediction value is preferably calculated for the examination site, in particular for the second embodiment of the indicator particle. However, it can also be provided that the path of the indicator particle from the introduction point to the detection point is modeled using the model, so that the progression of the actual value or the actual value range along the route covered by the indicator particle is subsequently known. This procedure is carried out primarily for the first embodiment and the third embodiment of the indicator particle. From the progression of the actual value or from the actual value range, a conclusion is then drawn as to whether the change in properties of the indicator particle due to the fluid is to be expected or not. This knowledge is subsequently used to verify and adapt the model. In the case of the third embodiment, it can be provided that the course of the actual value is determined along at least a part of the trajectory or the entire trajectory from the indicator properties of the individual partial regions. Overall, the described procedure is used to create a model or a digital twin of the fluid flow or the current flow conditions in the fluid-guiding device with extremely high accuracy.

The invention also relates to a method for operating a fluid-guiding device, wherein an actual value and/or an actual value range of at least one state variable of the fluid in a fluid flow present in the device is determined by means of at least one indicator particle introduced into the fluid, in particular using the method according to explanations within the scope of this description. It is provided that the at least one indicator particle is provided and designed for an irreversible property change of an indicator property of the indicator particle in the presence of a specific indicator value of the at least one state variable in the fluid flow and/or depending on or as a clear function of the actual value at the end of a specific period of time after the introduction of the indicator particle in the fluid, wherein the indicator particle is detected at a detection point, the indicator property of the indicator particle is evaluated and the actual value and/or the actual value range of the state variable is inferred from the indicator property upstream of the detection point.

The advantages of such a procedure or such a configuration of the fluid-guiding device have already been pointed out. Both the fluid-guiding device and the method for its operation can be developed in accordance with the explanations in the context of this description, so that reference is made to them in this respect. The note regarding actual value and actual value range still applies.

A development of the invention provides that if the actual value deviates from a previously determined actual value and/or from a predicted value determined using a model of the fluid flow, a malfunction of the fluid-guiding device is identified. Provision is therefore made, for example, for the actual value or actual value range to be determined using the method described at a first point in time, in particular immediately after the fluid-guiding device has been put into operation. The actual value or actual value range for the same examination point or route on the trajectory is then repeatedly determined with a time interval. If there is a change in the actual value or actual value range, i.e. if the last determined actual value or actual value range deviates from the previously determined actual value or actual value range, in particular by more than a permissible tolerance, the malfunction of the fluid-guiding device is identified and this is displayed, for example, to a user of the device. On the other hand, if the actual value or actual value range corresponds to the previously determined actual value or actual value range, preferably again within the desired tolerance, then proper functioning of the fluid-guiding device is recognized.

Additionally or alternatively, the model can be used to determine the prediction value, namely in particular for the examination point or route on the trajectory for which the actual value or actual value range is also determined using the at least one indicator particle. The model is preferably first calibrated and adjusted using the actual value or actual value range in such a way that the predicted value corresponds to the actual value or the predicted value range corresponds to the actual value range. The actual value or actual value range is then determined again, for example periodically, preferably by means of at least one further indicator particle, which is configured identically to the indicator particle, for example. At the same time, the prediction value or prediction value range is determined, namely in particular for the same examination point or route on the trajectory for which the actual value or actual value range is also determined. If the actual value or actual value range deviates from the predicted value, the malfunction is identified again. If the actual value corresponds to the predicted value or if the actual value range corresponds to the predicted value range, correct functioning is recognized. In both cases, the tolerance range already mentioned is preferably observed again. As a result, a diagnosis of the fluid-guiding device can be achieved during ongoing operation with extremely little effort and without a strong and permanent influence on the fluid flow.

The invention also relates to an indicator particle for determining an actual value and/or an actual value range of at least one state variable of a fluid in a fluid flow, wherein this determination is carried out in particular using the method explained in the context of this description. It is provided that the indicator particle is provided and designed for an irreversible property change of an indicator property of the indicator particle in the presence of a specific indicator value of the at least one state variable in the fluid flow and/or depending on or as a clear function of the actual value at the end of a specific period of time after introducing the indicator particle in the fluid. With regard to the advantages and possible developments, reference is made to the further explanations within the scope of this description.

A development of the invention provides that the state variable is a normal stress and/or a shear stress of the fluid and the indicator particle has a base body having a particle shell enclosing a cavity, wherein a reference pressure is present in the cavity and the particle shell is provided and designed in case of a deviation of the normal stress from the reference pressure by a certain pressure difference, to irreversibly change and/or break the indicator property in the form of its shape and/or wherein the particle shell is provided and designed in case the shear stress deviates from a reference stress to irreversibly change and/or break the indicator property in the form of its shape. The normal stress describes the fluid pressure.

The indicator particle should therefore be designed in such a way that it enables the fluid pressure to be determined, namely in particular at the examination point and/or along the path of the indicator particle from the introduction point to the detection point. For this purpose, the indicator particle has the base body, which in turn has the particle shell, which initially encloses the cavity in a fluid-tight manner. To this extent, the particle shell completely encloses the cavity. For example, the cavity has a volume of at least 50%, at least 75% or at least 90% based on the total volume of the base body. Before the indicator particle is introduced into the fluid, at least in the first variant, the reference pressure is present in the cavity, which corresponds in particular to the indicator value.

If the indicator particle is in the fluid, a force acting on the particle shell results from the pressure difference between the instantaneous actual pressure or the normal stress at the point at which the indicator particle is located and the reference pressure. If this force exceeds a specific limit value, i.e. if the fluid pressure deviates from the reference pressure by the specific pressure difference, the particle shell should break and/or change its shape, wherein both processes are irreversible. When the particle shell breaks, the main body or the indicator particle in particular bursts. The change in the shape of the particle shell takes place, for example, as an irreversible reduction in volume of the base body or the cavity. For example, the indicator particle or the particle shell is designed in such a way that when the shape changes or the breaking occurs, a pressure equalization takes place between the cavity and the fluid, so that the same or at least almost the same fluid pressure is subsequently present in the cavity as in the fluid. The change in shape or the bursting of the particle shell can be detected and evaluated particularly easily. In a second variant, the shear stress in the fluid is evaluated. If the shear stress deviates from the reference stress, in particular by a certain difference, then the irreversible change in shape or the breaking of the shell occurs again. The material of the particle shell is chosen based on the size of the indicator particle, the thickness of the particle shell, the reference pressure and the pressure difference or the shear stress difference between the shear stress and the reference stress. In principle, the size of the indicator particle can be in the micrometer and/or nanometer range. A polymer, a metal, a metal alloy, carbon or another suitable element can be used as the material of the base body. A combination of the materials mentioned, i.e. the use of at least two of the materials for the indicator particle or the base body, can also be provided.

A further development of the invention provides that on the base body there is a sensor material which provides the indicator property and which is state variable-sensitive, wherein the state variable is the fluid pressure, a fluid temperature or a fluid concentration. The sensor material is applied to the base body. The base body can be designed according to the above explanations and in this respect can have the cavity and the particle shell enclosing it. When using the sensor material, however, the base body can in principle have any desired configuration, i.e. it can also be solid, for example.

The sensor material is selected in such a way that it reacts sensitively to the state variable, i.e. changes its indicator property when the specific indicator value of the state variable is present. In other words, the sensor material is sensitive to state variables or state variable values. Moreover, the sensor material is designed or selected in such a way that this property change occurs irreversibly. The state variable, which is evaluated using the sensor material, can be, for example, the fluid pressure, the fluid temperature, the fluid concentration, a substance concentration, the normal stress or the shear stress. Of course, other state variables can also be evaluated with a corresponding sensor material. The use of the sensor material enables a particularly simple configuration of the indicator particle and also a simple evaluation of the indicator property.

In principle, a material that permanently changes one or more of its measurable properties as a function of an external state variable is preferred as the sensor material. This at least one property can be the optical reflectivity or the refractive index, the electrical resistance, the electrical capacitance, the photoluminescence or the chemical composition. Suitable materials include, in particular, multilayer porous photonic silicon crystals, thermochromic pigments and self-organizing isotropic or anisotropic nanostructures, in particular stimulated by various external state variables. A development of the invention provides that the base body, in particular the sensor material, is covered by a protective cover that can be degraded by the fluid, so that the base body or the sensor material is only exposed to the fluid a certain period of time after it has been introduced into the fluid. The protective cover enables a particularly precise spatial evaluation of the state variable or an evaluation or delimitation of the actual value or the actual value range. It covers the base body at least in certain regions or even completely. In this case, it preferably overlaps the sensor material at least in regions or completely, provided that the sensor material is present. The protective cover is designed in such a way that it degrades from the fluid or dissolves in the fluid or degrades on its own as soon as it is placed in or exposed to the fluid.

The degradation preferably takes place at a known and substantially constant rate, so that the thickness of the protective cover can be used to directly infer the period of time after which the fluid acts on the base body or the sensor material. In such an embodiment, the sensor material is particularly preferably selected in such a way that it only allows the property to change immediately when it comes into contact with the fluid. The property change is in turn sensitive to state variables or state variable values. If the protective cover is removed so that the sensor material is exposed to the fluid, the change in properties takes place in accordance with the actual value or actual value range when it comes into contact with the fluid. This enables a particularly precise determination of the actual value of the state variable or a particularly precise localization of the examination point.

A further development of the invention provides that several sensor elements and/or sensor regions are formed on the base body, wherein a first part of the sensor elements or sensor regions consists of the sensor material and a second part of the sensor elements or sensor regions consists of a sensor material that differs from the sensor material. In this respect, the indicator particle has different sensor materials, which are assigned to the multiple sensor elements or sensor regions. For example, the sensor materials are selected for the same state variable, but different indicator values and/or time periods. However, it can also be provided that the sensor materials are used to determine different state variables.

In principle, any number of sensor elements and/or sensor regions and any number of different sensor materials can be present. If only two sensor materials are provided, namely the sensor material and the sensor material that differs from this, then the sensor elements or sensor regions are divided into the first part and the second part. Of course, however, more different sensor materials can also be present, wherein the number of parts to which the sensor elements or sensor regions are divided corresponding to the number of different sensor materials. The use of the different sensor materials enables greater accuracy when determining the actual value or actual value range and/or a reduction in the time required for the determination.

A development of the invention provides that the sensor elements and/or sensor regions are covered by the protective cover with different cover thicknesses. Ultimately, this means that the sensor elements or sensor regions are exposed to the fluid after different periods of time after the indicator particle has been introduced into the fluid. If the sensor elements or sensor regions are used to determine actual values or actual value ranges of the same state variable and if the changes in their indicator properties are state variable value-sensitive for this purpose, either via different indicator values or indicator properties that are available as a clear function of the actual values, then the actual value or actual value range of the state variable can be detected at different times or different time intervals. This enables a particularly precise determination of the actual value or actual value range along the path covered by the indicator particle in the fluid, i.e. the trajectory. For example, the third embodiment of the indicator particle mentioned at the outset is designed with a large number of sensor elements or sensor regions, which are covered with different shell thicknesses. The protective cover is preferably dimensioned such that a first of the sensor elements or sensor regions is acted upon by the fluid immediately when the indicator particle is introduced into the fluid and a last of the sensor elements or sensor regions immediately before the detection point. This makes it possible to draw conclusions about the actual value or actual value range of the state variable over the entire trajectory.

Finally, the invention relates to a device for determining an actual value and/or an actual value range of at least one state variable of a fluid in a fluid flow by means of at least one indicator particle introduced into the fluid, in particular using the method according to the explanations in the context of this description. It is provided that the at least one indicator particle is provided and designed for an irreversible property change of an indicator property of the indicator particle when there is a certain indicator value of the at least one state variable in the fluid flow and/or as a clear function of the actual value at the end of a certain period of time after the introduction of the indicator particle into the fluid, wherein the device is provided and designed to detect the indicator particle at a detection point, to evaluate the indicator property of the indicator particle and to infer from the indicator property the actual value and/or the actual value range of the state variable upstream of the detection point. With regard to the advantages and possible advantageous developments, reference is made to the explanations within the scope of this description.

The invention is explained in more detail below with reference to the embodiments shown in the drawing, without restricting the invention. In the drawings:

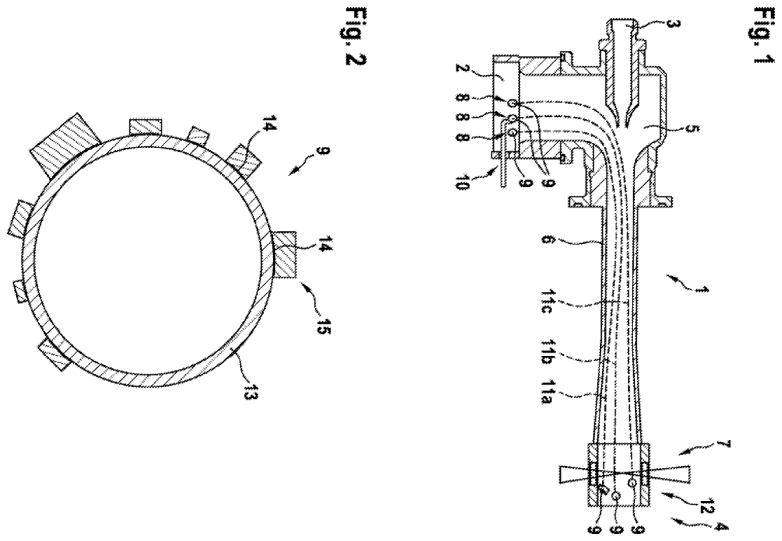

FIG. 1 is a schematic representation of a device for determining an actual value or actual value range of at least one state variable of a fluid, in particular a liquid fluid, in a fluid flow, and a fluid-guiding device,

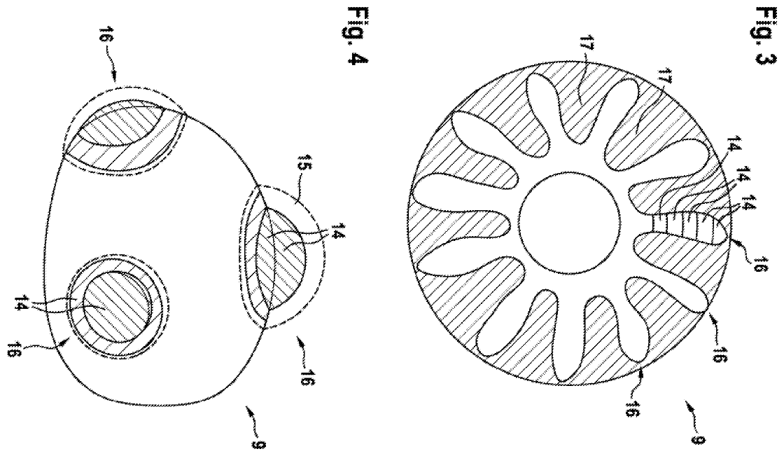

FIG. 2 is a schematic representation of a first embodiment of the indicator particle,

FIG. 3 is a schematic representation of a second embodiment of the indicator particle,

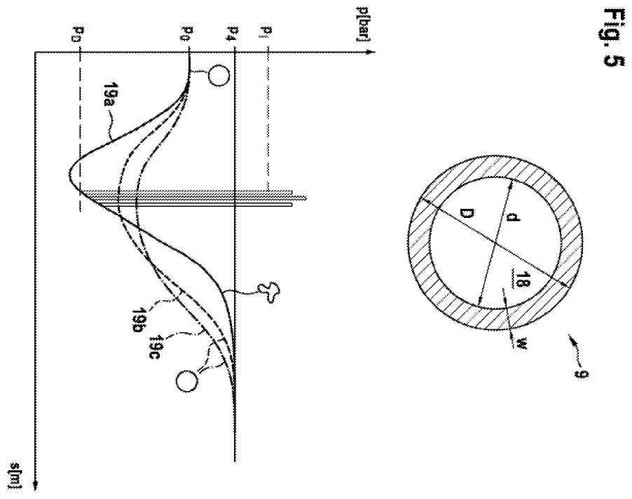

FIG. 4 is a schematic representation of a third embodiment of the indicator particle, and

FIG. 5 is an indicator particle and a diagram in which a pressure of the fluid is plotted along trajectories covered by a plurality of indicator particles in the fluid.

FIG. 1 shows a fluid-guiding device 1, namely a jet pump, which has a suction medium inlet 2, a propellant medium inlet 3 and an outlet 4. The propellant medium inlet 3 is designed in the form of a nozzle and opens into a mixing chamber 5. As an extension of the propellant medium inlet 3, a diffuser 6 is fluidically connected to the mixing chamber 5. The mixing chamber 5 is fluidically connected to the outlet 4 via the diffuser 6. The suction medium inlet 2 is also fluidically connected to the mixing chamber 5.

The fluid-guiding device 1 is supplied with a first fluid, the so-called propellant medium, at high pressure and—optionally—high temperature via the propellant medium inlet 3. Accelerating this first fluid through the nozzle 3 leads to a lower pressure of the first fluid in the mixing chamber 5 in relation to a pressure at the suction medium inlet 2. As a result, a second fluid, the so-called suction medium, which is present at the suction medium inlet 2—at an optionally low temperature—is conveyed from the suction medium inlet 2 into the mixing chamber 5 with a further reduction in pressure. The first fluid and the second fluid mix in the mixing chamber 5 and in the subsequent diffuser 6 with temperature equalization and renewed pressure increase before a fluid mixture consisting of the two fluids leaves the device through the outlet 4. In this case, the first fluid and the second fluid can be of the same substance.

The fluid-guiding device 1 is assigned a device 7 which is used to determine an actual value or an actual value range of at least one state variable of a fluid present in the fluid-guiding device 1. To this extent, the device 7 can also be referred to as a measuring device. In order to determine the actual value or the actual value range, one (or more) indicator particles 9 are introduced into the fluid at an introduction point 8 or at a plurality of introduction points 8 (in each case). In the embodiment shown here, the introduction point 8 is at the suction medium inlet 2. In terms of flow, it can also be present between the suction medium inlet 2 and the mixing chamber 5, i.e. in any case upstream of the mixing chamber, the diffuser 6 and the outlet 4. The indicator particles 9 are introduced by means of an introduction device 10, which is only indicated here. After the indicator particles 9 have been introduced into the fluid, they pass through the fluid-guiding device 1 starting from the introduction point 8 along a respective trajectory 11a, 11b or 11c. Downstream of the introduction point 8 there is a detection device 12 which is used to detect the indicator particles 9. The indicator particles 9 are detected, for example, by means of an optical detection device. This is indicated here only extremely schematically.

The indicator particles 9 are provided and designed in such a way that they are subjected to an irreversible property change of an indicator property of the respective indicator particle 9 when a specific indicator value of the state variable to be determined is present. In the embodiment shown here, the shape of the indicator particles 9 is used as an indicator property. It can be seen that in the region of the detection device 12 one of the indicator particles 9 has a changed shape, whereas the other indicator particles 9 have the same shape as when they were introduced into the fluid at the introduction point 8. From this it can be inferred that the indicator particle 9, which has changed its shape, has reached a region of the fluid flow along the respective trajectory 11a, 11b or 11c in which the state variable has an actual value which corresponds to an indicator value of the indicator particle 9 or exceeds or falls below this. If the actual value corresponds to this or if the actual value exceeds or falls below the indicator value, the irreversible property change occurs, in this case a change in shape. For this purpose, the indicator particles 9 are present in a first embodiment, in which the state variable is the fluid pressure and the indicator value of the indicator particles is selected such that the change in shape that occurs indicates the occurrence of cavitation in the fluid flow. FIG. 2 shows a schematic representation of a second embodiment of the indicator particle 9 or one of the indicator particles 9. In the embodiment shown, the indicator particle 9 has a base body 13 on which at least one sensor element 14 made of a sensor material (in the embodiment shown here several sensor elements 14) is formed. Only a few of the sensor elements 14 are identified as examples. In each case, several structurally identical sensor elements are preferred, distributed evenly over the surface of the indicator particle. The sensor elements 14 are covered by a protective cover 15, wherein the protective cover 15 for the various sensor elements 14 has different cover thicknesses that are constant over the respective sensor element 14. Structurally identical sensor elements preferably have the same protective cover, in particular with the same cover thickness. The protective cover 15 is designed in such a way that it is degraded by the fluid after the indicator particle 9 has been introduced into the latter, so that the sensor elements 14 are only directly exposed to the fluid after a certain period of time. The sensor material from which the sensor elements 14 are made is sensitive to state variables or state variable values. This means that the sensor material is subjected to the irreversible change in its indicator property as soon as it comes into contact with the surrounding fluid, wherein the indicator property changes according to the actual value or actual value range of the state variable immediately after the respective sensor element 14 has been exposed to the fluid. Provision can be made here for the property of the sensor material of the different sensor elements 14 to change irreversibly when the same or different indicator values are present. Provision can also be made for the property of the sensor material of the different sensor elements 14 to change as a clear function of the actual value of the state variable directly after the sensor elements 14 come into contact with the surrounding fluid. The sensor material can additionally or alternatively be designed for different state variables of the fluid.

The use of a plurality of identical sensor elements distributed over the particle surface enables the indicator property of an indicator particle to be recorded optically in a very simple manner. An unambiguous assignment of the cover thickness and surface of a sensor element allows a very simple assignment between the detected indicator property and the point in time (after the indicator particle has been introduced into the fluid) at which the actual value or actual value range was present.

FIG. 3 shows a schematic representation of a third embodiment of the indicator particle 9. In principle, reference is made to the above explanations and only the differences are discussed below. These lie in the fact that several sensor element arrangements 16 emanate from the base body 13, of which only a few are identified as examples. Each of these sensor element arrangements 16 has a plurality of sensor elements 14. This is also only indicated as an example. The sensor element arrangements 16 each extend outwards starting from the base body 13 and are spaced apart from one another. The protective cover 15 is present in the intermediate spaces 17 present between the sensor element arrangements 16 (again only identified as an example). After the indicator particle 9 has been introduced into the fluid, the protective covering 15 is removed from the outside inwards. This means that the sensor elements 14 are subjected to the fluid one after the other in terms of time.

Each of the sensor elements 14 is designed in such a way that the property of the sensor material changes irreversibly if the specific indicator value of the state variable is present when the fluid is applied to it. Alternatively, each of the sensor elements 14 is designed in such a way that the property of the sensor material changes irreversibly as a clear function of the actual value of the state variable directly after the sensor material comes into contact with the surrounding fluid. The sensor elements 14 are particularly preferably designed in such a way that the irreversible property change is only possible immediately at the beginning of the exposure of the respective sensor element 14 to the fluid. Accordingly, when evaluating the indicator property of the indicator particle 9 or the indicator properties of the sensor elements 14, a time sequence of the actual value or actual value range of the state variable along one of the trajectories 11a, 11b and 11c can be evaluated.

FIG. 4 shows a schematic representation of a fourth embodiment of the indicator particle 9. Reference is again made to the above explanations. Again, there are a number of sensor element arrangements 16 which each have a number of sensor elements 14. The sensor elements 14 are each arranged or formed directly on the base body 13. For example, there is a central sensor element 14 which is encompassed by the other sensor elements 14, for example in a ring shape. Each of the sensor element arrangements 16 is covered by the protective cover 15 which is formed on the base body 13 in the shape of a segment of a sphere, for example. The protective cover 15 is arranged in such a way that it overlaps at least part of the sensor elements 14, preferably all of the sensor elements 14, before the indicator particle 9 is introduced into the fluid. Since the protective cover 15 is dissolved by the fluid over time and the thickness of the cover of the protective cover 15 for the sensor elements 14 is different, the sensor elements 14 are again exposed to the fluid one after the other. This configuration of the indicator particle 9 also enables fine temporal resolution of the course of the actual value or actual value range of the state variable, in particular along the respective trajectory 11a, 11b or 11c of the indicator particle 9 (Langrange's description) or the local actual values of the state variable in the fluid flow (Euler's description), preferably after the trajectories 11a, 11b and 11c of the indicator particles 9 have been determined within the framework of a calibrated model of the fluid flow and the particle movement.

FIG. 5 shows an indicator particle 9 and a diagram in which a pressure p is plotted over a distance s of the trajectories 11a, 11b and 11c for the fluid-guiding device 1 described with reference to FIG. 1. The indicator particle 9 shown is representative of several identical indicator particles 9. These each have the base body 13, which is hollow and made of a defined material. The base body 13 is defined by an outer diameter D, a cavity 18 with an inner diameter d, a reference pressure in the cavity 18 of the base body 13 and a specific wall thickness w=D−d. A curve 19a shows the course of the pressure along the trajectory 11a, a course 19b along the trajectory 11b and a course 19c along the trajectory 11c. All trajectories start at pressure p₀ at the introduction point 8 and end at pressure p₄ in the outlet 4. For the indicator particle 9 assigned to the trajectory 11a, the local fluid pressure, starting from the pressure p₀, initially falls below the vapor pressure p_{D} of the fluid, so that cavitation bubbles form, which implode as a result of the pressure increase after the vapor pressure p_{D} is exceeded and lead to very high pressure peaks in the fluid (above the specified indicator value p_{I}), which then cause a permanent change in shape of the indicator particle. This is not the case for the indicator particles 9 assigned to the trajectories 11b and 11c, so that these—as indicated—retain their shape.

1. Method for determining an actual value and/or an actual value range of at least one state variable of a fluid in a fluid flow by means of at least one indicator particle (9) introduced into the fluid, characterized in that the at least one indicator particle (9) is provided and designed for an irreversible property change of an indicator property of the indicator particle (9)
in the presence of a specific indicator value of the at least one state variable in the fluid flow, and/or
as a clear function of the actual value at the end of a certain period of time after the indicator particle (9) is introduced into the fluid,
wherein the indicator particle (9) is detected at a detection point, the indicator property of the indicator particle (9) is evaluated and the actual value and/or the actual value range of the state variable upstream of the detection point is inferred from the indicator property.

2. Method according to claim 1, characterized in that the at least one indicator particle (9) is part of a large number of indicator particles (9) which are introduced into the fluid, wherein the indicator value of the state variable for a first part of the indicator particles (9) corresponds to a first indicator value and for a second part of the indicator particles (9) corresponds to a second indicator value and/or the period of time corresponds to a first period of time for the first part of the indicator particles and to the second period of time for the second part of the indicator particles.

3. Method according to one of the preceding claims, characterized in that the first part of the indicator particles (9) and the second part of the indicator particles (9) are introduced into the fluid simultaneously or in a time-delayed manner and/or at the same point of introduction (8) or at spaced-apart points of introduction (8), wherein the first part is provided with an unchangeable first identification independent of the respective indicator property and the second part is provided with an unchangeable second identification independent of the respective indicator property.

4. Method according to one of the preceding claims, characterized in that the at least one indicator particle (9) is detected and the indicator property is evaluated without contact in the fluid or after the at least one indicator particle (9) has been removed from the fluid.

5. Method according to one of the preceding claims, characterized in that if the property change does not occur, the indicator value (9) is changed until the property change occurs, or if the property change occurs, the indicator value is changed until the property change does not occur, wherein from a first indicator value of the indicator value, at which the property change did not occur, and from a second indicator value of the indicator value at which the property change occurred, the actual value and/or the actual value range of the state variable is inferred.

6. Method according to one of the preceding claims, characterized in that at least one prediction value for the state variable is calculated using a model of the fluid flow and the movement of a particle in the fluid flow, in particular along the trajectory of the at least one modeled indicator particle, and is verified using the at least one indicator particle (9), wherein the model is adjusted to the actual value and/or the actual value range if the prediction value deviates from the actual value and/or actual value range determined by means of the at least one indicator particle (9).

7. Method for operating a fluid-guiding device (1), wherein an actual value and/or an actual value range of at least one state variable of the fluid in a fluid flow present in the device (1) is determined by means of at least one indicator particle (9) introduced into the fluid, in particular using the method according to one or more of claims 1 to 6, characterized in that the at least one indicator particle (9) is responsible for an irreversible change in the properties of an indicator property of the indicator particle (9)
is designed and introduced in the presence of a specific indicator value of the at least one state variable in the fluid flow, and/or
as a clear function of the actual value at the end of a certain period of time after the indicator particle (9) into the fluid,
wherein the indicator particle (9) is detected at a detection point, the indicator property of the indicator particle (9) is evaluated and the actual value and/or the actual value range of the state variable upstream of the detection point is inferred from the indicator property.

8. Method according to claim 7, characterized in that if the actual value and/or the actual value range deviates from a previously determined actual value and/or actual value range and/or from a predicted value and/or predicted value range determined using a model of the fluid flow, a malfunction of the fluid-guiding device (1) is recognized.

9. Indicator particle (9) for determining an actual value and/or an actual value range of at least one state variable of a fluid in a fluid flow, in particular using the method according to one or more of claims 1 to 6, characterized in that the indicator particle (9) is provided and designed for an irreversible change in properties of an indicator property of the indicator particle (9) is designed and introduced in the presence of a specific indicator value of the at least one state variable in the fluid flow, and/or as a clear function of the actual value at the end of a certain period of time after the indicator particle (9) has been introduced into the fluid.

10. Indicator particle according to claim 9, characterized in that the state variable is a normal stress and/or a shear stress of the fluid and the indicator particle (9) has a base body (13) having a particle shell enclosing a cavity, wherein a reference pressure is present in the cavity and the particle shell is provided and designed to irreversibly change and/or break the indicator property in the form of its shape when the normal stress deviates from the reference pressure by a specific pressure difference, and/or wherein the particle shell is provided and designed to irreversibly change and/or break the indicator property in the form of its shape for this purpose when the shear stress deviates from a reference tension.

11. Indicator particle according to one of the preceding claims, characterized in that on the base body (13) there is a sensor material which provides the indicator property and is state variable-sensitive, wherein the state variable is the fluid pressure, a fluid temperature or a fluid concentration.

12. Indicator particle according to one of the preceding claims, characterized in that the base body (13) is covered by a protective cover (15) so that the base body or the sensor material is only exposed to the fluid after the specific period of time has elapsed after being introduced into the fluid.

13. Indicator particle according to one of the preceding claims, characterized in that a plurality of sensor elements (14) and/or sensor regions are formed on the base body (13), wherein a first part of the sensor elements (14) or sensor regions made of the sensor material and a second part of the sensor elements (14) or sensor regions consists of a sensor material that is different from the sensor material.

14. Indicator particle according to one of the preceding claims, characterized in that the sensor elements (14) and/or sensor regions are covered by the protective cover (15) with different cover thicknesses.

15. Device (7) for determining an actual value and/or an actual value range of at least one state variable of a fluid in a fluid flow by means of at least one indicator particle (9) introduced into the fluid, in particular using the method according to one or more of claims 1 to 6 and/or of the indicator particle according to one or more of claims 9 to 14, characterized in that the at least one indicator particle (9) is responsible for an irreversible change in the properties of an indicator property of the indicator particle (9)
is designed and introduced in the presence of a specific indicator value of the at least one state variable in the fluid flow, and/or
as a clear function of the actual value at the end of a certain period of time after the indicator particle (9) into the fluid,
wherein the device (7) is provided and designed to detect the indicator particle (9) at a detection point, to evaluate the indicator property of the indicator particle (9) and to infer the actual value and/or the actual value range of the state variable upstream of the detection point from the indicator property.
